(19) United States
(12) Patent Application Publication
(10) Pub. No.: US 2018/0043268 A1
(43) Pub. Date: Feb. 15, 2018

(54) Player Movement Contest System

(71) Applicant: Lane Arden Johnston, Clarkston, MI (US)

(72) Inventor: Lane Arden Johnston, Clarkston, MI (US)

(21) Appl. No.: 15/236,441

(22) Filed: Aug. 14, 2016

(51) Int. Cl. A63F 13/828; A63F 13/792; A63F 13/35

(52) U.S. Cl. CPC A63F 13/828; A63F 13/35; A63F 13/792

(57) ABSTRACT

The present invention relates to assigning points to professional sports player movement from team to team via a draft or free agency. Contests involve picking the correct player for professional sports draft picks or from selecting the correct team that free agent players sign a contract with and competing with other people for the best score. Contests are based on points that are rewarded for correct predictions of the player movement with a variety of draft rounds or free agent periods.

### BACKGROUND OF THE INVENTION

Free agency periods and professional sports garner much attention and excitement for fans of sports. In unrestricted free agency, players can move from their team to another team, or stay with their current team. Restricted free agency players have special restrictions on the terms in which they can retain or change employment status with their athletic club teams. In drafts, players move from college, high school or junior teams or teams from other countries to a professional team that controls their contract rights. Free agent players can be grouped by position, skill level, and other categories that can be used to create a contest to select what team they predict will sign them to a contract. For example, a free agent class of wide receivers could be ranked by their desirability and skill level. The higher the rank, the more points they could be worth for a correct guess of the team that would sign them. A contest could be created of all the players or just wide receivers, and the more points earned from the selection of the correct teams they ultimately sign with would result in a contest win.

A contestant's selections of players to be drafted to a round and selection number does not exclude that player from getting selected by any other contestant. There can be contests where the value of each selection in the list are valued similarly, weighed on the ranking of the player, or after the first incorrect answer the contestant's game is over.

Similar in an entry draft, players get selected by teams in allotted positions Teams can trade the allotted positions to other teams to move up or down in rounds. Selecting the correct team that makes a draft pick is not a sure thing. Picking the player that actually gets selected by the team in the round and pick number is not a trivial matter and can take strategy foreseeing the team's personnel needs and the best available player to that can be selected There are always unexpected selections and trades that happen and contestants can compete in contests predicting what they believe will happen in the draft.

Contestants could just be interested in certain field positions (like quarterbacks, power forwards, etc. . . . ) and what players get drafted and in what order. This gives contestants a rooting interest in free agency beyond hoping their favorite team signs the best player(s) available for their team. Professional teams that contestants select, whom they believe will sign the free agent are not excluded as a selection from other contestants. For example, the top rated free agent in the NFL is selected by a contestant to go to Miami. The other contestants can also select Miami as the team they believe will be the one that signs that player.

### SUMMARY OF THE INVENTION

Before a professional sports draft or a free agency signing period begins, a person would log into a website or a mobile device application. They would find a contest to choose from. The contests would vary in the rules and requirements. If the contest has a wage amount, it would come out of their account, the contest would be paid for, and they would be able to participate in the contest. They would be eligible to win prizes. The contests would vary on how many items to pick from for a draft pick, whether it be just selecting the player, team, or player position, or some or all for them. In the case of selecting players for a draft, they would select a player next to the draft round and pick the number for the designated start point and end point, making a unique player selection for each draft pick. They could be picking the players to be drafted in the third round, from the first pick to the last pick in that round. Other options for the contest is the wage amount, and how many other people can participate in the same contest, and how many payout positions there will be.

The person would fill in the required item(s) for the contest. Some designated time before the draft starts, the selections would be locked in and could not be changed.

As the draft begins, the points would accumulate for the correct selections and they would be able to see how they are doing in relation to the other contestants. Once the draft is over at the point the contest ends, the winners are credited with the amount their position pays out.

An example of a professional draft contest in effect, there could be a contest for selecting the players only for the first round for a wager of 10 dollars. They would pay for the contest from their account on the computer game system. A commission of 10% is taken out per wager. The top 3 players in a participant pool of 50 people win prizes. The total prize pool is 450. The top prize would be 275 dollars, second place would be 100 dollars, and third place would get 75 dollars. The winners' accounts would be credited with the prize amount. The players that did not win, would not receive anything.

For selecting a free agent contest, a wage, a participant amount, and a winner amount are all options a player can use to determine the contest to play in. Once a contest is selected, a list of the top free agent players is available and teams that the player could sign with are available to choose from. Once the official free agency period begins, the selections are locked in. As the players sign contracts with the teams in the league they play for, points are given for the correct selections Once all the players on the list have signed contracts with a team, the contest is over. The total points are accumulated and the winners' accounts are credited with the prize money. An example of a free agent contest could be selecting the teams for the top 15 free agents for professional basketball. The wager for the contest is 5 dollars and 100 people can participate. There is a 5% commission on the wager, so the prize pool would be 450 dollars. The top 50 players would receive $9.50.

### DESCRIPTION OF DRAWINGS

FIG. 1. shows
(1) Devices to connect to the contest system can include computers, smart phones, tablets, and other communication systems that allow logging in the contest system
(2) Using a device, the contestant will come to a log in screen and will need to create a profile with a user name and password and other necessary information when they first visit the system. Once they have a user account setup, they can log in with their username and password or social media account (i.e. Facebook).
(3) A contest list will be available for the contestant to choose a contest to enter and participate in. It could be a draft selection contest or a free agency selection contest. Information about each available contests or previously entered contests will be available. For open contests the following data could be provided:
   a) data such as the cost of entering will be listed
   b) the number of current contestants in the contests
   c) the total number of contestants that the contest is for
   d) what league the contest is for
   e) the contest type, free agency or draft
   f) when the contest starts
   g) when the contest ends
   h) scoring method
   i) any other extra information about the contest

For closed contests, the information for current scoring would be provided if the contest is ongoing. For completed contests, the position of the player and scoring would be provided. If the position was high enough to qualify for a prize, the prize amount would be given Information on the prize amount and redeeming or collecting it will be provided.

Linking to social media of the information of completed contests and contest details would be available. An example would be winning a contest of 1000 players and linking that information to Twitter for bragging rights.
(4) The available contest types could be free or a paid contest. Free contests could include cash prizes, credits to play other paid contests, gift cards, or other prizes. Some free contests could be just for fun and have no reward for winning or placing in the top. An example of another prize would be free entry to another contest. Paid contests would have prizes such as cash, gift cards, or other prizes.
(5) There would be screen to select where to draw funds to participate in paid contests A payment would be required to be made to participants in contests that have a payment due.
(6) Once a contest is selected and any payment due is made, the selections for the contest is required. Fields with the necessary data available to fill in the prediction would be available. If the contest is requiring teams to be selected for free agents that will sign with, the teams would be selectable. Similarly, if selecting players to match up with a draft position, the players available could be selected from.
(7) Valid payment choices to pay for contests or to collect winnings could be bank accounts, credit cards, online payment services, or other payment options (money order, etc.)
(8) Completed and closed contests will be listed with the history of scoring, placement in comparison to all the other contestants on those contests, prizes won if that occurred, and other pertinent information. If the contest has not yet completed, updated scoring will occur and events unfold in relation to the contest. For example, if a closed contest is for free agency and selecting teams that a player will sign for and a player listed in the contest signed with a team, the results of the scoring, correct or incorrect will happen.
(9) When the contest has been completed and the results are posted, they will be available for the player. It will clearly show if they had qualified to win a prize or did not. If they did win a prize, the amount would be listed. It would have a full run down of the scoring of the contest along with the prizes rewarded for each place that qualified.
   The contest scoring is laid out when the contest is selected and the scoring results are provided in detail. There are various ways to score the contests for correct answers. They can include:
   a) Knock out
   b) Progressive
   c) Accumulative
   d) Weighted scoring
   e) Bonuses for consecutive correct selections
(10) If a prize was won, it could be collected in a number of ways. It could be returned back to them by the same method they paid for the contest. They could request a check, put on an online account, or other payment methods.
(11) Once a contest is over, it will be listed for a given time period and then retired.

FIG. 2.

Contest selection screen. It gives the player the information about the contest.

FIG. 3.

[1] The round of the draft

[2] The pick of the draft in [1] round

[3] Point value for a correct selection of the player in round [1], pick [2]

[3] Point value for a correct pick for the round [1], pick [2]

[4] The player that gets drafted in round [1], pick [2]

[5] The position of the player [4] that predicted to get drafted

[6] The actual player that gets pick in round [1] pick [2]

[7] The actual position for the player that gets picked in round [1] pick [2]

FIG. 4.

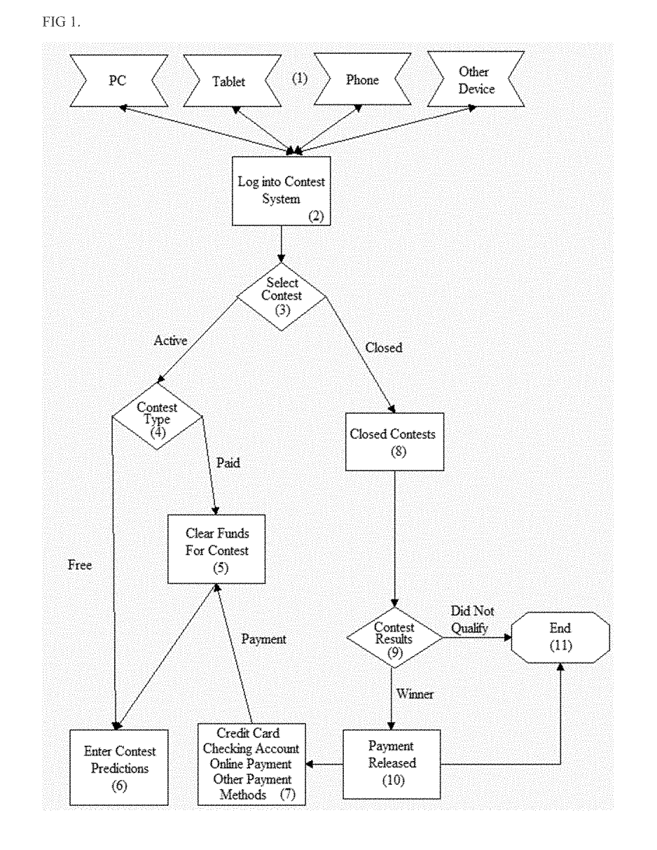

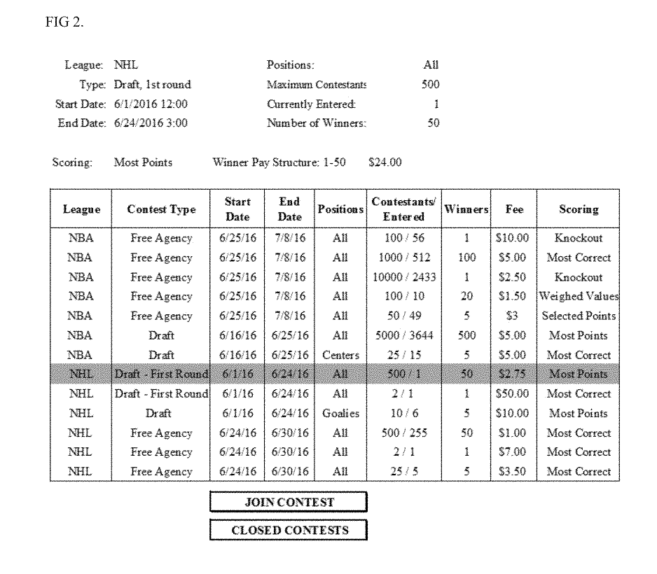

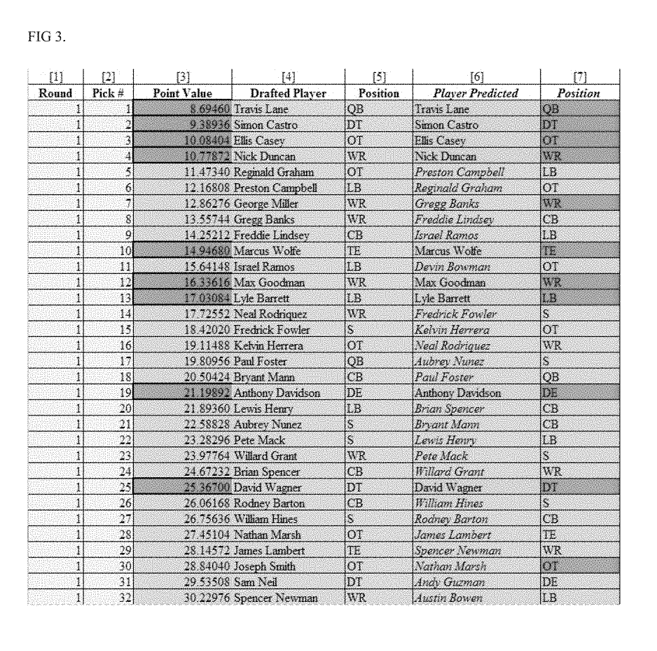

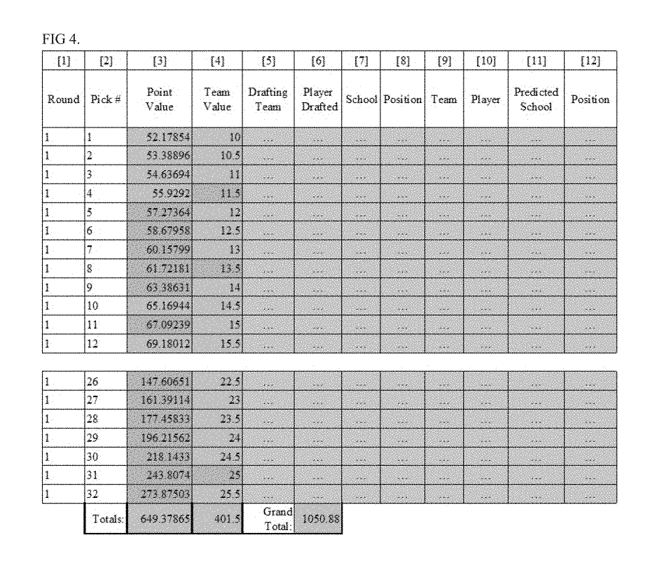

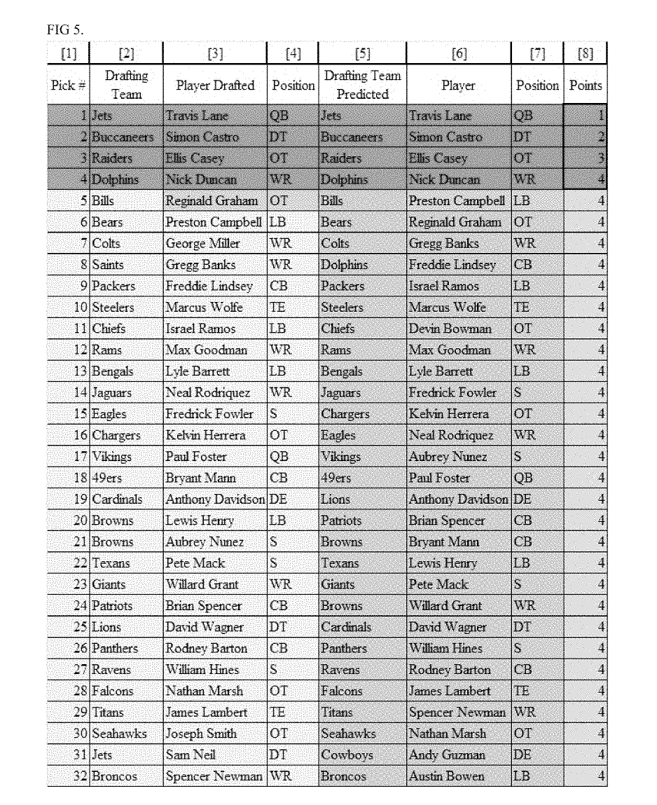

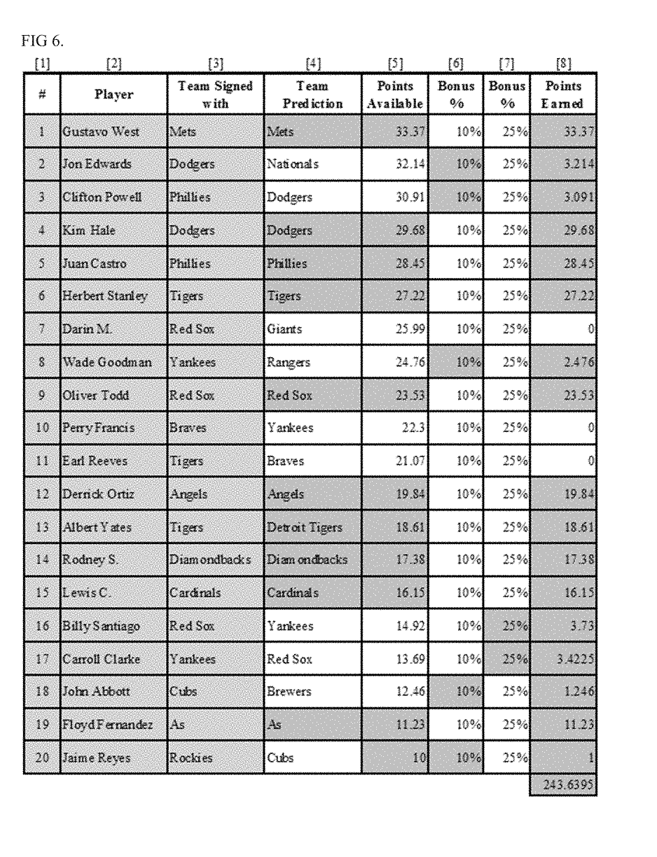

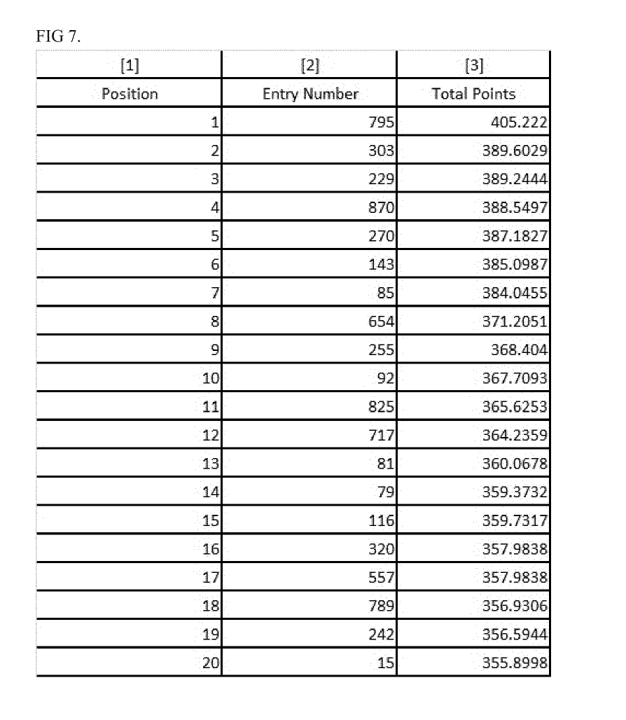

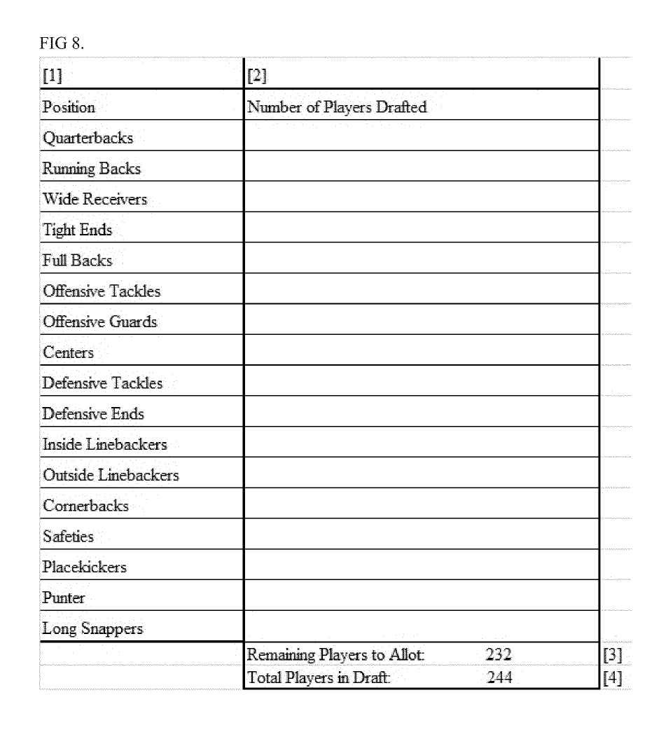

[1] The round of the draft

[2] The pick of the draft in [1] round

[3] Point value for a correct selection of the player in round [1], pick [2]

[4] Point value for a correct selection of the team in round [1], pick [2]

[5] The team that drafted the pick [2] in round [1]

[6] The actual player that gets pick in round [1] pick [2]

[7] School of the Player drafted

[8] The position of the player [4] that got drafted in round [1], pick [2]

[9] The team predicted to make the pick [2], round [1]

[10] The player predicted to get selected for pick [2], round [1]

[11] The school of the predicted player to get drafted for pick [2], round [1]

[12] The position of the player predicted to get selected for pick [2], round [1]

FIG. 5.

[1] Draft pick position

[2] Team that makes the selection in position [1]

[3] Player selected in pick position [1]

[4] Position played by the player [2]

[5] Team predicted to be selected in pick position [1]

[6] Player predicted to be selected in pick position [1]

[7] Position of player predicted to be selected in pick position [1]

[8] Points earned, if either player or team is incorrect, zero points are earned for the rest of the picks

FIG. 6.

[1] Ranking position of the free agent

[2] Name of the free agency in position [1]

[3] New team the free agent signs with

[4] New team predicted that the free agent signs with

[5] Point value the free agent is worth when correctly picking the correct team to sign with

[6] Bonus percentage if the correct league is picked for the player but not the correct team

[7] Bonus percentage if the correct division is picked for the player but not the correct team

[8] Points earned for correct selections

FIG. 7.

[1] The ranked position of entry [2]

[2] The entry number of the person participating

[3] Total score of correct draft picks selected for entry [2]

FIG. 8.

[1] Position of player position that get drafted

[2] Number of players predicted to be selected in the position [1]

[3] Remaining number of players can be allotted for [2]

[4] Total number of players to be selected in the draft that should sum all of the selections in column [2]

What we claim is:

1. A method of assigning points to professional draft picks rewarded for a correct prediction of the following before the event begins:
(a) the player selected for a specific pick position and draft round
(b) and/or the team selecting the player for a specific pick position and draft round
(c) and/or the specific role that a player takes on the field for a specific pick position and draft round
(d) and/or the school that the player last attended before getting selected in a draft
(e) the number of players at a certain position drafted in a round or in an entire draft

2. The method of claim 1 includes compensatory drafts, traded draft picks, and entry draft picks earned based on the previous year's standings

3. The method of claim 1 includes the following types of drafts; entry draft, expansion drafts, and a dispersal draft

4. The method of claim 1 include the NFL draft, NHL draft, MLB draft, MLS draft, and NBA draft

5. The method of claim 1 where the point value can be calculated by a formula based on the round of the draft and/or the draft position

6. The method of claim 1 where the points can be assigned from a fixed pool of points and can be assigned to the draft picks and rounds by the participant with defined rules

7. The method of claim 6 where the assigned points need to be spread out for the entry range of draft picks for the competition with a minimum and maximum point value per pick

8. The method of claim 5 where the formula can be a linear function, an exponential function per points system, a static value per draft pick and drafting round

9. The method of claim 5 where assigning points to draft picks starting from the first pick from a designated starting point until an invalid selection is made and then no more points are rewarded

10. The method of claim 1 where a person can make a prediction of the player to be drafted for specific draft pick and round for professional sports drafts before the draft occurs and earn the assigned points for correct selections

11. The method of claim 10 where the selection for the player(s) predicted to be drafted for a specific draft pick and round is done electronically or manually

12. The method of claim 10 electronically is a communication network such as the Internet or other suitable network

13. The method of claim 1 is that the assigned points for correct picks are totaled up

14. The method of claim 13 is where the total point value is compared against one or more people

15. The method of claim 14 for operating a wagering system, wherein the wagering system is configured on professional sports drafts point values earned

16. The method of assigning points to professional sports players who have an unrestricted free agent status when the free agency period begins

17. The method of claim 16 can be calculated by formula based on a ranking system, a fixed pool of points to be distributed to all players, or a flat value per player, and/or points for selecting the division and league as the actual team the player signs a contract with

18. The method of claim 16 where participants select teams that the sports players that are free agents sign contracts with

19. The method of claim 18 where before the free agency period begins, selections of teams that the free agent signs with are locked in and rewarded the points placed on the pick for correct predictions on the team that the free agent signs a contract with

20. The method of claim 19 where assigned point values for correct picks are totaled up

21. The method of claim 20 is where the total point value is compared against one or more people

22. The method of claim 21 for operating a wagering system, wherein the wagering system is configured on point values earned

23. The method of claim 18 where the selection for the player(s) predicted to be drafted for a specific draft pick and round is done electronically or manually

24. The method of claim 23 electronically is a communication network such as the Internet or other suitable network
